(19) United States
(12) Patent Application Publication
(10) Pub. No.: US 2025/0372075 A1
(43) Pub. Date: Dec. 4, 2025

(54) ARTIFICIAL INTELLIGENCE RADIO

(71) Applicant: FYI.FYI, Inc., Los Angeles, CA (US)

(72) Inventor: William Adams, Los Angeles, CA (US)

(21) Appl. No.: 19/219,801

(22) Filed: May 27, 2025

Related U.S. Application Data
(60) Provisional application No. 63/653,134, filed on May 29, 2024.
(60) Provisional application No. 63/653,701, filed on May 30, 2024.
(60) Provisional application No. 63/737,479, filed on Dec. 20, 2024.

(51) Int. Cl. G10L 13/027; G06F 16/583; G06F 16/635; G10L 15/22

(52) U.S. Cl. CPC G10L 13/027; G06F 16/583; G06F 16/635; G10L 15/22

(57) ABSTRACT

A computer system may receive from a user a selection of a preferred artificial intelligence (“AI”) persona from a list of AI personas, wherein: each AI persona from the list of AI personas comprises a unique accent, unique traits, and a unique background history. Additionally, the computer system may process one or more digital project files using the preferred AI persona, wherein: the preferred AI persona identifies information of interest within the one or more digital project files based upon the unique traits and the unique background history of the preferred AI persona. The computer system may then play one or more music audio files for the user. After a music audio file completes, the computer system may generate, with the preferred AI persona, an audio conversation with the user, wherein the audio conversation is based upon the information of interest within the one or more digital project files.

### CROSS-REFERENCE TO RELATED APPLICATIONS

This application claims the benefit of and priority to each of the following: 1) U.S. Provisional Patent Application Ser. No. 63/737,479 filed on 20 Dec. 2024 and entitled “ARTIFICIAL INTELLIGENCE RADIO,” 2) U.S. Provisional Patent Application Ser. No. 63/653,701 filed on 30 May 2024 and entitled “ARTIFICIAL INTELLIGENCE RADIO,” and 3) U.S. Provisional Patent Application Ser. No. 63/653,134 filed on 29 May 2024 and entitled “ARTIFICIAL INTELLIGENCE RADIO.” The entire contents of each of the aforementioned applications is incorporated herein by reference in their entireties.

### BACKGROUND

The field of digital media and interactive computing has rapidly evolved with the increasing integration of artificial intelligence technologies. As computing systems become more interconnected and content delivery becomes more personalized, the demand for sophisticated user experiences has led to the exploration of new modalities for information access and engagement.

In particular, advancements in cloud computing, machine learning, and natural language processing have enabled new forms of human-computer interaction. These include voice assistants, AI-driven recommendation systems, and adaptive user interfaces. Such systems are often designed to analyze large volumes of digital content, respond to user input, and adapt behavior based on learned preferences or contextual cues.

Simultaneously, digital audio broadcasting and internet radio have continued to serve as popular channels for the delivery of music and spoken-word content. With the proliferation of mobile devices and always-connected computing environments, users now routinely access streaming media in a wide range of contexts—from entertainment to education, productivity, and beyond.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system for operating an interactive artificial intelligence digital radio station, including: one or more processors; and one or more computer-storage media having stored thereon executable instructions that when executed by the one or more processors configure the computer system to perform at least the following: receive from a user a selection of a preferred artificial intelligence (“AI”) persona from a list of AI personas, wherein: each AI persona from the list of AI personas includes a unique accent, unique traits, and a unique background history; receive from a user a selection of one or more digital project files, wherein: at least one digital project file is managed by a third party; access the one or more digital project files within a content storage database, wherein the content storage database includes: one or more storage databases; process the one or more digital project files using the preferred AI persona, wherein: the preferred AI persona identifies information of interest within the one or more digital project files based upon the unique traits and the unique background history of the preferred AI persona; play one or more music audio files for the user, wherein the one or more music audio files are selected based upon the one or more digital project files; and after a music audio file completes, generate, with the preferred AI persona, an audio conversation with the user, wherein the audio conversation is based upon the information of interest within the one or more digital project files.

In some aspects, the techniques described herein relate to a computer-implemented method for operating an interactive artificial intelligence digital radio station, including: receiving from a user a selection of a preferred artificial intelligence (“AI”) persona from a list of AI personas, wherein: each AI persona from the list of AI personas includes a unique accent, unique traits, and a unique background history; receive from a user a selection of one or more digital project files, wherein: at least one digital project file is managed by a third party; accessing the one or more digital project files within a content storage database, wherein the content storage database includes: one or more storage databases; processing the one or more digital project files using the preferred AI persona, wherein: the preferred AI persona identifies information of interest within the one or more digital project files based upon the unique traits and the unique background history of the preferred AI persona; playing one or more music audio files for the user, wherein the one or more music audio files are selected based upon the one or more digital project files; and after a music audio file completes, generating, with the preferred AI persona, an audio conversation with the user, wherein the audio conversation is based upon the information of interest within the one or more digital project files.

In some aspects, the techniques described herein relate to a computer-storage media including one or more physical computer-storage media having stored thereon computer-executable instructions that, when executed at a processor, cause a computer system to perform a method for operating an interactive artificial intelligence digital radio station, the method including: receiving from a user a selection of a preferred artificial intelligence (“AI”) persona from a list of AI personas, wherein: each AI persona from the list of AI personas includes a unique accent, unique traits, and a unique background history; receive from a user a selection of one or more digital project files, wherein: at least one digital project file is managed by a third party; accessing the one or more digital project files within a content storage database, wherein the content storage database includes: one or more storage databases; processing the one or more digital project files using the preferred AI persona, wherein: the preferred AI persona identifies information of interest within the one or more digital project files based upon the unique traits and the unique background history of the preferred AI persona; playing one or more music audio files for the user, wherein the one or more music audio files are selected based upon the one or more digital project files; and after a music audio file completes, generating, with the preferred AI persona, an audio conversation with the user, wherein the audio conversation is based upon the information of interest within the one or more digital project files.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1 depicts a schematic of a computer system for an embodiment of an artificial intelligence radio software application.

FIG. 2 depicts an embodiment of a user interface for a project file.

FIG. 3 depicts another embodiment of a user interface for a project file.

FIG. 4 depicts an embodiment of a user interface for selection of digital files on interest.

FIG. 5A depicts a flow between example user interfaces.

FIG. 5B depicts a continued flow of the example user interfaces.

FIG. 6 depicts a flowchart of steps in a method for operating an artificial intelligence radio.

### DETAILED DESCRIPTION

Interactive media has undergone substantial transformation with the proliferation of artificial intelligence (AI) technologies. Modern users expect personalized, engaging, and dynamic content experiences across multiple digital platforms. While streaming audio services and AI-based chat systems have become commonplace, a major technical challenge remains: integrating user-specific media content with conversational AI systems in a way that delivers contextually relevant, emotionally intelligent, and continuously adaptive interactions.

Traditional digital radio and streaming platforms generally provide passive listening experiences with minimal interaction or personalization. Even AI-driven assistants tend to rely on pre-defined responses or rigid logic trees, offering limited engagement that fails to adapt meaningfully to evolving user content or preferences. Furthermore, while cloud-based storage allows users to aggregate diverse content (such as music, documents, and multimedia projects), there remains no unified system that intelligently interprets such content to generate personalized audio conversations contextualized by the user's ongoing digital projects.

For example, a limitation in conventional systems is the lack of semantic adaptability—i.e., the ability to tailor audio interactions and media playback dynamically based on user-selected content from third-party-managed digital files. Additionally, there is no conventional framework that allows users to configure AI personas with unique behavioral traits, background histories, and preferences that meaningfully influence how content is interpreted and presented. This hampers the system's ability to deliver authentic, user-aligned conversational experiences.

Moreover, maintaining coherence and relevance in AI-generated interactions as source content updates in real time presents another significant challenge. Existing systems lack robust methods for detecting, processing, and integrating updates to cloud-based or remote content repositories in a way that preserves conversational continuity while reflecting new information. They also fail to address the privacy, fidelity, and contextual integrity of content removal—creating compliance and user trust concerns.

In at least one embodiment, a computer system for operating an interactive artificial intelligence (AI) digital radio station comprises one or more processors and one or more computer-storage media storing instructions that, when executed by the one or more processors, cause the computer system to perform various operations as described herein. For example, the computer system may receive, from a user, a selection of a preferred AI persona from a list of available AI personas. Each AI persona may include a unique accent, unique traits, and a unique background. As used herein, an “AI persona” comprises a virtual character profile comprising unique traits, a background history, and optionally a unique voice model, used to guide semantic filtering, dialogue generation, and user interaction behavior.

The computer system may also receive, from the user, a selection of one or more digital project files. As used herein, a “digital project file” comprises one or more files, folders, data structures, or content collections—curated by a user or third party—containing multimedia, textual, or metadata elements associated with a specific topic, theme, or use case. These digital project files may be managed by the user and/or a third-party entity. The computer system accesses the selected digital project files from a content storage database, which may include one or more cloud-based storage systems. Upon accessing the digital project files, the system processes the content using the preferred AI persona. The preferred AI persona analyzes the digital project files to identify information of interest based on the unique traits and unique background associated with that AI persona.

The system may then play one or more music audio files for the user. These music audio files may be selected by the AI persona based on content found in the digital project files. Upon completion of playback of a music audio file, the AI persona may generate and initiate an audio conversation with the user. This conversation may be based on the information of interest previously identified within the digital project files.

Accordingly, the disclosed embodiment provides an AI-driven radio station that is highly customizable according to the user's preferences. For example, the user may select an AI persona with traits and a background that reflect the user's own traits and background, or the user may select an AI persona that is otherwise of interest to the user. The AI persona 140 then uses its traits and background to curate music selections and generate conversational content in accordance with the selected digital project files.

In some embodiments, the user may engage in real-time conversation with the AI persona, including interrupting music playback or initiating dialogue at any point during the operation of the AI radio station. Furthermore, as described in more detail below, the user may select from multiple digital project files curated by the user and/or third parties. Such project files may be associated with specific topics, themes, individuals, or subject matter—for example, a project file may relate to a local professional sports team, a historical topic such as World War II, a culinary topic such as Italian cuisine, a local news outlet, or any other topic of interest. The AI persona crawls through the selected digital project files and identifies information of interest based on both its defined traits and background, as well as based on the user's prior chat history with the AI persona.

In one embodiment, a user-curated digital project file may be a structured collection of multimedia content, documents, or web links assembled by the user to reflect a specific interest, project, or theme. The user may create and manage the digital project file through a graphical user interface provided by the AI radio application, such as by uploading files, adding URLs, tagging content, or providing textual summaries. These user-curated project files may include, for example, a folder of PDF research notes on climate policy, a set of bookmarked podcast episodes, a playlist of personal audio recordings, or annotated photographs from a recent trip.

The AI persona accesses and processes user-curated project files using the same semantic and conversational pipeline as it does with third-party-managed files. However, in this case, the system may prioritize metadata or annotations provided by the user to enhance semantic understanding. For example, user-defined tags (e.g., “urgent,” “personal,” “to-review”) may be weighted more heavily by the persona-specific point-of-interest model when determining conversation topics. This allows the AI persona to engage the user in highly personalized discussions that reflect the user's intent, history, and priorities, thereby supporting project planning, journaling, research synthesis, or casual reflection in a more meaningful and customized manner.

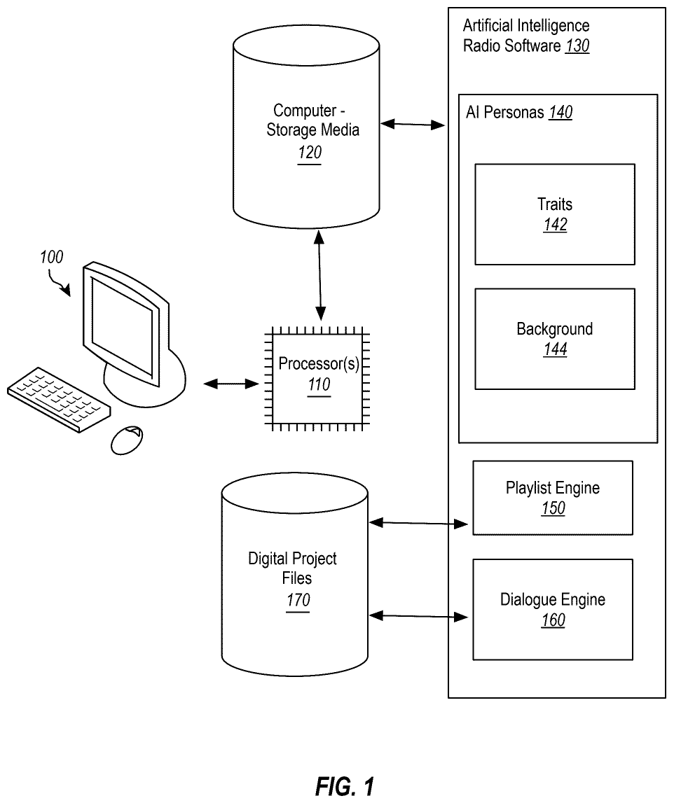

Turning now to the figures, FIG. 1 illustrates a schematic diagram of a computer system 100 for implementing an embodiment of an AI radio software application. The computer system 100 includes one or more processors 110 and one or more computer-storage media 120 storing instructions in the form of an AI radio software application 130. The AI radio software application 130 may comprise various components, such as APIs, engines, and algorithms, that cooperate to perform the operations of the AI radio system. It should be appreciated that the illustrated modular structure is provided by way of example and is not intended to limit the scope of implementation.

The AI radio software application 130 comprises one or more AI personas 140. The AI personas 140 may include a plurality of AI personas, each comprising unique traits 142 and unique backgrounds 144. In some embodiments, the AI personas may also include unique accents. Each AI persona 140 may have traits 142 such as preferred topics of interest, age-based characteristics (e.g., an 80-year-old persona versus a 21-year-old persona), gender, sense of humor, and typical emotional responses. Each AI persona 140 may further have background information 144 including, but not limited to, cultural or ethnic origin, geographic origin (e.g., country, state, or city), educational background, and familial or professional history. In at least one embodiment, each AI persona 140 is associated with a unique name and may optionally be associated with a representative image or avatar that visually conveys aspects of the AI persona's traits 142 and background 144.

In some embodiments, the AI radio software 130 associates each AI persona 140 with a persona-specific semantic filter, a dynamically weighted point-of-interest model, and a persistent conversation state graph that together govern how the AI persona 140 interprets, prioritizes, and presents information extracted from digital project files 170. The semantic filter is a machine-learned vectorized model trained to reflect the AI persona's unique traits 142 and background history 144, including factors such as tone preferences, topical biases, cultural context, humor tolerance, and emotional affect. This filter may be instantiated as a parameterized transformer-based embedding layer that pre-processes the raw input content from the digital project files 170, assigning contextual salience scores to content features (e.g., named entities, events, stylistic markers) based on their alignment with the persona's profile. The result is a vectorized relevance map that determines which elements of the input content are passed forward to the point-of-interest module.

The point-of-interest model may comprise a multi-layer classifier pipeline that applies both rule-based logic and probabilistic models (e.g., Bayesian relevance networks or attention-based scoring layers) to identify and rank content fragments that warrant conversational elaboration. These fragments may include semantically dense paragraphs, image captions, media metadata, or dialogue snippets, each tagged with content type, sentiment score, and topical vector embeddings. These data are then used to populate or update the AI persona's conversation state graph, which may comprise a directed acyclic graph structure in which nodes represent conversational concepts or user engagement events and edges denote logical or narrative transitions. The AI persona's conversation graph may be stored within the dialogue engine 160. The graph evolves over time based on user interactions, the chronological ordering of content updates, and ongoing sentiment analysis. During audio conversation generation, the dialogue engine 160 queries the conversation state graph in conjunction with the persona's real-time emotional model and contextual memory buffer to synthesize natural language utterances that are consistent with the AI persona's identity and reflect both historical user interactions and recent content updates. This architecture enables each AI persona to deliver a rich, coherent, and individualized conversational experience that adapts to evolving content while preserving persona continuity.

In addition to the AI personas component 140, the AI radio software 130 may further include a playlist engine 150 and a dialogue engine 160. One or both of the playlist engine 150 and the dialogue engine 160 may be configured to communicate with digital project files 170. The computer system 100 may receive a selection of one or more digital project files 170 from the user. In at least one embodiment, at least a subset of the digital project files 170 is managed by a third-party content provider. Upon receiving the user's selection, the playlist engine 150 and/or the dialogue engine 160 may access the corresponding digital project files 170 from a content storage database, which may include local storage, cloud-based storage, or a hybrid of both.

After accessing the digital project files 170, the preferred AI persona 140 processes the content and identifies information of interest based on the preferred AI persona's traits 142 and background 144. For example, an AI persona 140 with a Japanese cultural background may prioritize content within a World War II project file that pertains to the Pacific theater, while downplaying or omitting content related to the European theater. In another example, an AI persona 140 with a humorous disposition may highlight comedic content within a digital project file 170 containing comic strips sourced from a local news feed.

Similarly, the playlist engine 150 may play music files directly embedded within the digital project files 170, such as an MP3 file of Beethoven's Sixth Symphony. The AI persona 140 may then initiate a dialogue with the user regarding the musical content, drawing upon its traits 142 and background 144—for instance, referencing Beethoven's influence on modern pop music if the AI persona 140 expresses a strong preference for contemporary genres.

In another scenario, the playlist engine 150 may identify related musical content not embedded in the digital project files 170, but inferable from their content. For example, if a digital project file 170 relates to Brazil, the playlist engine 150 may identify and play a Brazilian musical selection. The AI persona 140, if configured with a Brazilian background 144, may then comment on a past performance of the song in the AI persona's city of origin.

In some embodiments, the AI persona 140 may also engage in general or topical conversation with the user upon completion of a music track. For instance, the AI persona 140 may identify a breaking news item within a digital project file 170 sourced from a news feed and inform the user accordingly. The decision to report the news and the manner of delivery may be influenced by the AI persona's traits 142 and background 144. For instance, an AI persona with a trait related to fitness may not report the opening of a new fast-food restaurant in the user's city. In contrast, that AI persona may report news item relating to an upcoming athletic competition.

Accordingly, in at least one embodiment, using the playlist engine 150, the computer system 100 plays one or more music audio files selected based on the contents of the digital project files 170. After completion of a music audio file, the dialogue engine 160—configured to operate with the selected AI persona 140—generates an audio conversation with the user, based on the information of interest extracted from the digital project files.

In at least one embodiment, the audio conversation generated by the dialogue engine 160 is output to the user through a text-to-speech (TTS) synthesis pipeline. The TTS engine may utilize either a generic voice model or a persona-specific voice model that reflects the unique accent, tone, and speech style of the selected AI persona 140. The text-to-speech pipeline receives structured natural language content generated by the dialogue engine 160 and converts it into synthesized audio using neural TTS architectures such as TACOTRON 2 or FASTSPEECH, optionally combined with vocoder models like WAVEGLOW or HIFI-GAN to produce high-quality waveforms. The TTS may be hosted locally on the user's device, in a cloud-based system, or in a combination of the two.

In some embodiments, the system supports fine-grained voice parameter control, enabling dynamic modulation of speech pitch, speed, and emotional tone based on the persona's defined traits and context of the content. For example, an AI persona with a humorous trait may deliver conversational output with expressive prosody and exaggerated intonation, whereas a serious persona may adopt a slower, more formal cadence. These settings may be encoded into metadata accompanying the dialogue output and interpreted by the TTS engine during synthesis. The resulting audio is then streamed or played locally to the user through device speakers, headphones, or other audio output hardware.

In some embodiments, the computer system 100 further configures the AI persona 140 to identify updated material within the digital project files 170. This may occur on a predetermined time cycle, allowing the AI persona 140 to periodically reevaluate content for updates. Alternatively, or in addition, the computer system 100 may receive a notification from the digital project files 170 indicating that the material has been updated, in which case the AI persona 140 is triggered to process the updated content accordingly.

For example, In some embodiments, the computer system 100 includes an update-detection function operatively coupled with the dialogue engine 160 and configured to inform a selected AI persona 140 of changes to digital project files 170. This process can be implemented through a combination of passive and active mechanisms. In a passive mode, the AI persona 140 may be registered as a subscriber to push-based notification services associated with the digital project file 170 sources—such as RSS feeds, webhook integrations, or cloud-based storage APIs (e.g., AMAZON S3 event notifications, GOOGLE CLOUD Pub/Sub, or DROPBOX webhooks) —which emit structured update signals upon file modification or metadata change events. These signals are parsed by an event listener within the AI radio software 130 and queued for contextual analysis by the dialogue engine 160.

In an active mode, the computer system 100 may initiate a time-based polling operation, wherein the AI persona 140 is triggered at a predetermined interval to perform a delta comparison between current and previously cached content snapshots, using lightweight checksum or hash-diff algorithms, or semantic diff techniques (e.g., natural language or image embedding comparisons for textual or visual content, respectively). Upon detecting a material change, the AI persona 140 reprocesses the relevant digital project files 170, recalculates points of interest based on its personalized semantic filters (derived from its traits and background), and updates its conversation state graph accordingly. The dialogue engine 160 then synthesizes a responsive audio segment to be played to the user following the next scheduled or user-invoked interaction. This architecture ensures that the AI persona 140 remains contextually aware of evolving content landscapes and delivers dynamic, up-to-date commentary aligned with user interests. When updated content is identified, the dialogue engine 160, in collaboration with the AI persona 140, generates a follow-up audio conversation that reflects the updated material.

The computer system 100 also enables dynamic selection of a different AI persona from the list of AI personas 140, wherein the newly selected AI persona 140 (now the “preferred AI persona”) includes a different unique accent, different unique traits 142, and a different unique background 144. Upon selection, the computer system 100 reprocesses the existing digital project files 170 using the different AI persona 140, which identifies new or different information of interest. As a result, the playlist engine 150 may select a new set of music audio files aligned with the different AI persona's interpretation of the project content. Once the new music audio file concludes, the dialogue engine 160 generates a different audio conversation with the user, based on the new information of interest derived by the different AI persona 140 from the digital project files 170.

In certain embodiments, the digital project files 170 may include image-based content. The AI radio software application 130 is configured to process this image-based content using the preferred AI persona 140. Based on this visual content, the playlist engine 150 selects one or more music audio files tailored to the visual themes or subjects represented in the images. After playback, the dialogue engine 160 and the AI persona 140 generate an audio conversation with the user, wherein the conversation is grounded in the image-based content. Accordingly, the system described herein provides a flexible, personalized AI radio experience that adapts dynamically to various forms of user content and persona configurations.

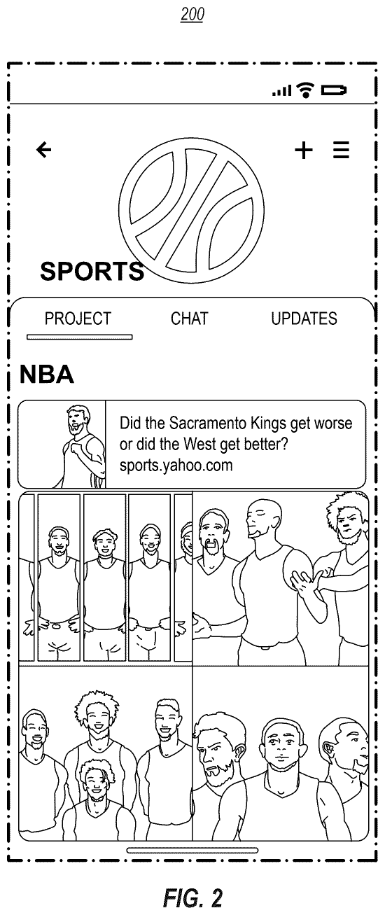

FIG. 2 illustrates a user interface 200 in which a user engages with a third-party-curated digital project file 170 focused on a specific topic—in this case, sports. Upon the user's selection of this project file, the AI persona 140 is instantiated with its corresponding traits 142 and background 144, which include vectorized models representing preferred subject matter, linguistic tone, and socio-cultural perspective. In at least one embodiment, the AI persona 140 analyzes the content of the selected digital project file using a semantic extraction pipeline that employs a transformer-based encoder model tuned to the persona's profile. This pipeline identifies and scores entities, facts, media, and phrases according to a relevance matrix personalized to the AI persona. These extracted data points are encoded into an internal memory map and associated with a content-state graph, which maps content elements to their source identifiers, types (e.g., audio, text, image), timestamps, and relevancy metadata. This data structure forms the basis of the AI persona's interactive response generation, determining both the substance and style of downstream audio conversations with the user.

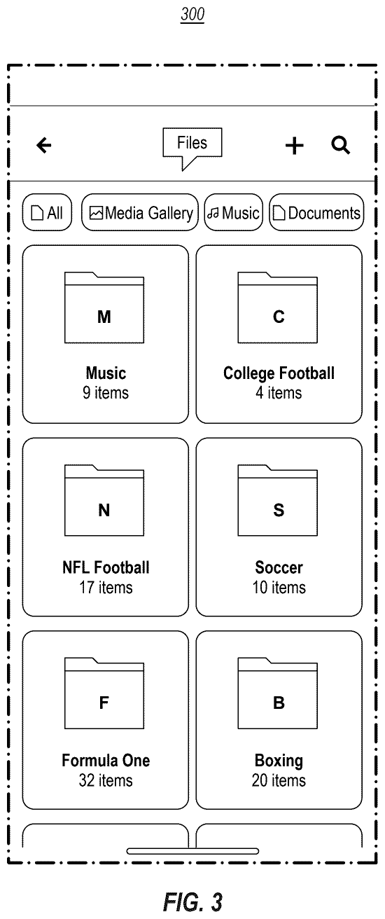

FIG. 3 depicts a backend user interface 300 through which a third-party content provider manages the assets associated with digital project files. The folders shown in interface 300 organize multimedia elements, metadata, and topical structures that are accessible to the AI radio software 130 via cloud-based content APIs. In at least one embodiment, when the content provider removes an item from the digital project file—such as deleting a folder of NFL-related articles or retracting an embedded music clip—this action triggers a change event detected by a monitoring service integrated with the AI radio software. The monitoring layer may use persistent webhook subscriptions or periodically executed delta comparison agents that evaluate version signatures (e.g., SHA-256 content hashes, metadata timestamps, or logical content version vectors) between previously indexed content and the live repository. Upon detecting removal, the system logs the change and propagates a deletion notice to the AI persona 140, which in turn invokes a “forgetting routine” on the affected data.

In at least one embodiment, the forgetting routine executed by the AI persona 140 operates on two levels: immediate exclusion of removed content from future conversational eligibility and soft-retention of the content's historical trace for interaction continuity. Specifically, the AI persona's memory architecture may include a dual-graph framework composed of a “content-state graph” and a “conversation-state graph.” The content-state graph maps individual content assets to active memory nodes, and when a deletion event is registered, the affected nodes are tombstoned—that is, flagged as logically deleted but retained in archival form for dependency resolution. These nodes are dereferenced from future dialogue generation processes via a filtering mechanism that excludes any invalidated nodes during conversation planning. Meanwhile, the conversation-state graph—which encodes prior user interactions, sentiment trends, and response pathways—remains intact. As a result, while the AI persona retains memory of the fact that a conversation occurred, it no longer references or builds upon any content that has since been removed.

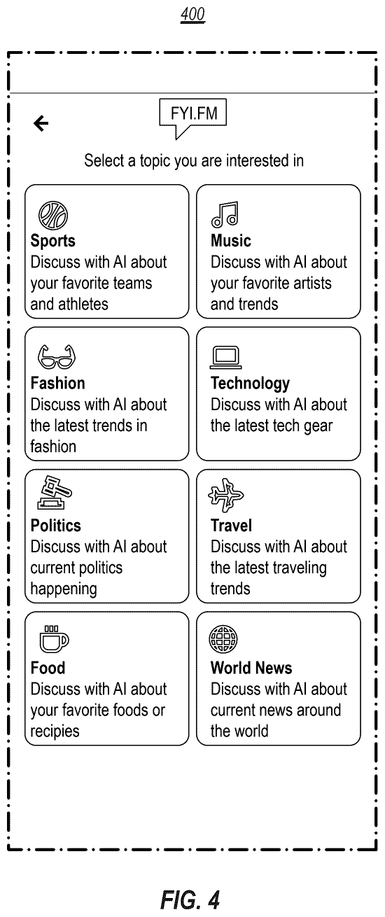

FIG. 4 illustrates a user interface 400 from which users may browse and select among various topical digital project files 170 curated by third-party content providers. In at least one embodiment, upon selection, the AI persona 140 is loaded with both a base configuration (i.e., traits 142 and background 144) and an operational state context comprising (1) valid active content embeddings, (2) expired or removed content identifiers, and (3) user-specific conversational history. This layered context enables the AI persona to operate in a hybrid memory mode: maintaining personalization and engagement continuity while remaining compliant with third-party content governance. Removed content is automatically pruned from the persona's conversation suggestion buffer—an indexed shortlist of likely user engagement topics—thereby ensuring that future generated conversations will not reference expired material. Internally, any semantic or topical embeddings related to removed content are zeroed or masked in the persona's short-term content memory.

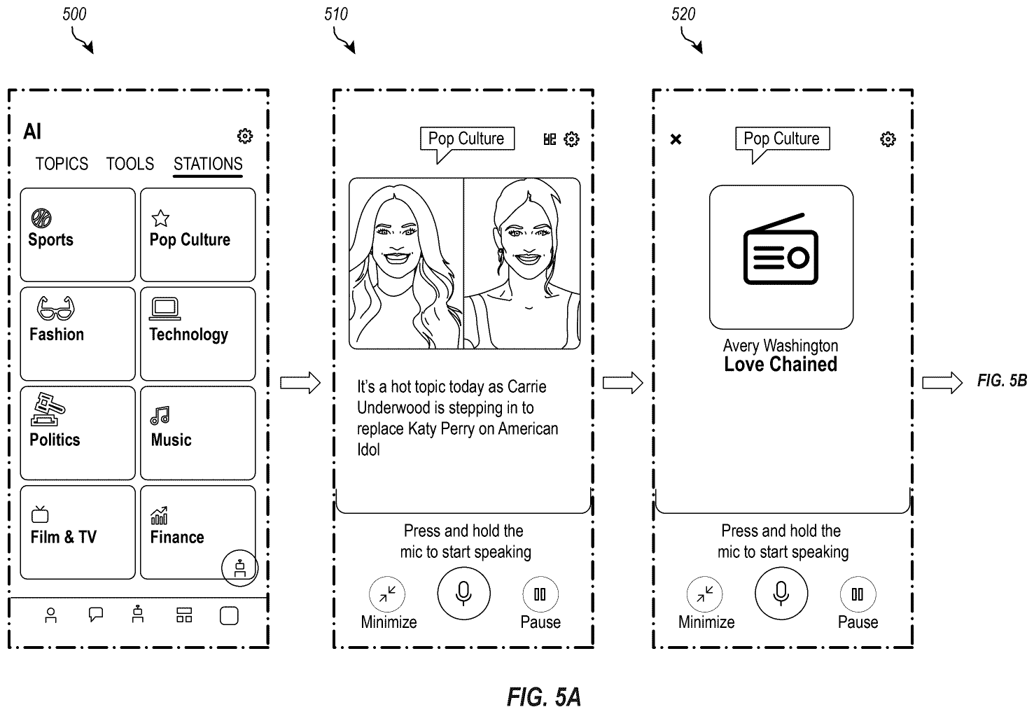

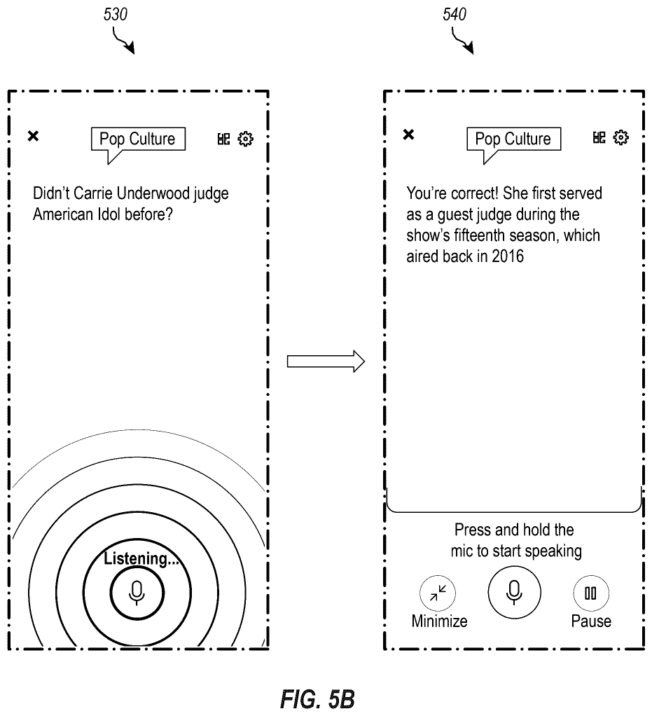

As illustrated in FIGS. 5A and 5B, the user interfaces 500, 510, 520, 530, 540 depict the dynamic experience of interacting with the AI persona 140 through music playback and conversation. When a user progresses through these stages, the AI persona 140 continually queries its current conversation-state graph to determine appropriate dialogue transitions and topics. If a previously discussed topic is tied to content that has since been removed, the corresponding node within the content-state graph is dereferenced, and the AI persona 140 dynamically adjusts its transition paths to bypass that node. The dialogue engine 160 ensures that even if a user implicitly or explicitly asks about the removed topic, the AI persona 140 will recognize the node's deprecated status and respond accordingly, such as by stating that the information is no longer available or by gently redirecting the user to adjacent active content. This behavior is implemented via a gating mechanism within the dialogue engine 160 that evaluates node status before advancing traversal of the persona's state graph.

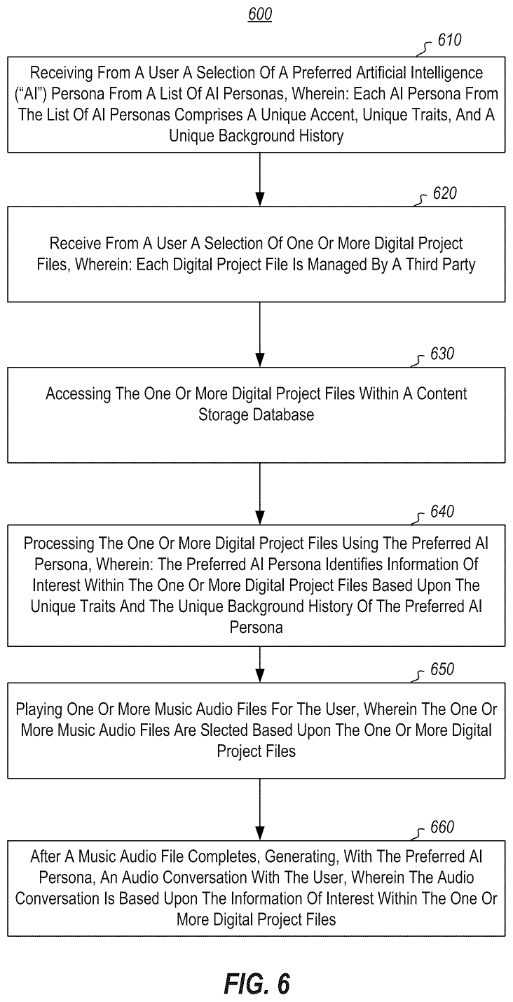

FIG. 6 provides a systems-level flowchart of how an embodiment of an AI radio software 130 operates. In block 600, the AI persona 140 is selected and instantiated with its traits 142 and background 144. In block 610, the user selects a digital project file 170. Block 620 involves accessing the current version of that file from cloud storage. The AI persona processes the content at block 630 using a persona-specific point-of-interest model, resulting in a set of content embeddings and topic mappings. Block 640 involves the playlist engine 150 selecting music content that aligns with the content and persona profile. Block 650 reflects the dialogue engine 160 synthesizing an audio conversation with the user. At block 660, if the content is updated—either through new additions or deletions—the AI persona evaluates content-version deltas using a hash-based diffing engine and adjusts its internal graphs accordingly. If content is removed, the forgetting routine executes, tombstoning the removed content from the active graph while preserving a filtered trace in the conversation history index. This ensures that the AI persona will no longer mention the removed content in future conversations while maintaining memory fidelity for the user's interaction history, enabling consistent and compliant engagement.

The disclosed technology is illustrated, for example, according to various features described below. Various examples of features of the disclosed technology are described as numbered features (1, 2, 3, etc.) for convenience. These are provided as examples and do not limit the disclosed technology. It is noted that any of the dependent features may be combined in any combination and placed into a respective independent feature. The other features can be presented in a similar manner.

Feature 1. A computer system for operating an interactive artificial intelligence digital radio station, comprising: one or more processors; and one or more computer-storage media having stored thereon executable instructions that when executed by the one or more processors configure the computer system to perform at least the following: receive from a user a selection of a preferred artificial intelligence (“AI”) persona from a list of AI personas, wherein: each AI persona from the list of AI personas comprises a unique accent, unique traits, and a unique background history; receive from a user a selection of one or more digital project files, wherein: at least one digital project file is managed by a third party; access the one or more digital project files within a content storage database, wherein the content storage database comprises: one or more storage databases; process the one or more digital project files using the preferred AI persona, wherein: the preferred AI persona identifies information of interest within the one or more digital project files based upon the unique traits and the unique background history of the preferred AI persona; play one or more music audio files for the user, wherein the one or more music audio files are selected based upon the one or more digital project files; and after a music audio file completes, generate, with the preferred AI persona, an audio conversation with the user, wherein the audio conversation is based upon the information of interest within the one or more digital project files.

Feature 2. The computer system of any of the preceding features, wherein the executable instructions include instructions that are executable to configure the computer system to: cause the preferred AI persona to identify updated material within the one or more digital project files.

Feature 3. The computer system of any of the preceding features, wherein the executable instructions include instructions that are executable to configure the computer system to: cause the preferred AI persona to identify updated material within the one or more digital project files, wherein the preferred AI persona is caused to identify updated material based upon a predetermined time cycle.

Feature 4. The computer system of any of the preceding features, wherein the executable instructions include instructions that are executable to configure the computer system to: receive a notification from the one or more digital project files that material has been updated; and cause the preferred AI persona to identify updated material within the one or more digital project files.

Feature 5. The computer system of any of the preceding features, wherein the executable instructions include instructions that are executable to configure the computer system to: after the music audio file completes, generate, with the preferred AI persona, the audio conversation with the user, wherein the audio conversation is based upon the updated material within the one or more digital project files.

Feature 6. The computer system of any of the preceding features, wherein the executable instructions include instructions that are executable to configure the computer system to: receive from the user another selection of a different AI persona from the list of AI personas, wherein: the different AI persona comprises a different unique accent, different unique traits, and a different unique background history.

Feature 7. The computer system of any of the preceding features, wherein the executable instructions include instructions that are executable to configure the computer system to: process the one or more digital project files using the different AI persona, wherein: the different AI persona identifies different information of interest within the one or more digital project files based upon the different unique traits and the different unique background history of the different AI persona; play one or more different music audio files for the user, wherein the one or more different music audio files are selected based upon the one or more digital project files; and after a different music audio file completes, generate, with the different AI persona, a different audio conversation with the user, wherein the different audio conversation is based upon the different information of interest within the one or more digital project files.

Feature 8. The computer system of any of the preceding features, wherein the one or more digital project files comprise image-based content.

Feature 9. The computer system of any of the preceding features, wherein the executable instructions include instructions that are executable to configure the computer system to: process the image-based content using the preferred AI persona; play the one or more music audio files for the user, wherein the one or more music audio files are selected based upon the image-based content; and after the music audio file completes, generate, with the preferred AI persona, the audio conversation with the user, wherein the audio conversation is based upon the image-based content.

Feature 10. A computer-implemented method for operating an interactive artificial intelligence digital radio station, comprising: receiving from a user a selection of a preferred artificial intelligence (“AI”) persona from a list of AI personas, wherein: each AI persona from the list of AI personas comprises a unique accent, unique traits, and a unique background history; receive from a user a selection of one or more digital project files, wherein: at least one digital project file is managed by a third party; accessing the one or more digital project files within a content storage database, wherein the content storage database comprises: one or more storage databases; processing the one or more digital project files using the preferred AI persona, wherein: the preferred AI persona identifies information of interest within the one or more digital project files based upon the unique traits and the unique background history of the preferred AI persona; playing one or more music audio files for the user, wherein the one or more music audio files are selected based upon the one or more digital project files; and after a music audio file completes, generating, with the preferred AI persona, an audio conversation with the user, wherein the audio conversation is based upon the information of interest within the one or more digital project files.

Feature 11. The computer-implemented method of any of the preceding features, further comprising: causing the preferred AI persona to identify updated material within the one or more digital project files.

Feature 12. The computer-implemented method of any of the preceding features, further comprising: causing the preferred AI persona to identify updated material within the one or more digital project files, wherein the preferred AI persona is caused to identify updated material based upon a predetermined time cycle.

Feature 13. The computer-implemented method of any of the preceding features, further comprising: receiving a notification from the one or more digital project files that material has been updated; and causing the preferred AI persona to identify updated material within the one or more digital project files.

Feature 14. The computer-implemented method of any of the preceding features, further comprising: after the music audio file completes, generate, with the preferred AI persona, the audio conversation with the user, wherein the audio conversation is based upon the updated material within the one or more digital project files.

Feature 15. The computer-implemented method of any of the preceding features, further comprising: receiving from the user another selection of a different AI persona from the list of AI personas, wherein: the different AI persona comprises a different unique accent, different unique traits, and a different unique background history.

Feature 16. The computer-implemented method of any of the preceding features, further comprising: processing the one or more digital project files using the different AI persona, wherein: the different AI persona identifies different information of interest within the one or more digital project files based upon the different unique traits and the different unique background history of the different AI persona; playing one or more different music audio files for the user, wherein the one or more different music audio files are selected based upon the one or more digital project files; and after a different music audio file completes, generating, with the different AI persona, a different audio conversation with the user, wherein the different audio conversation is based upon the different information of interest within the one or more digital project files.

Feature 17. The computer-implemented method of any of the preceding features, wherein the one or more digital project files comprise image-based content.

Feature 18. The computer-implemented method of any of the preceding features, further comprising: process the image-based content using the preferred AI persona; and play the one or more music audio files for the user, wherein the one or more music audio files are selected based upon the image-based content.

Feature 19. The computer-implemented method of any of the preceding features, further comprising: after the music audio file completes, generating, with the preferred AI persona, the audio conversation with the user, wherein the audio conversation is based upon the image-based content.

Feature 20. A computer-storage media comprising one or more physical computer-storage media having stored thereon computer-executable instructions that, when executed at a processor, cause a computer system to perform a method for operating an interactive artificial intelligence digital radio station, the method comprising: receiving from a user a selection of a preferred artificial intelligence (“AI”) persona from a list of AI personas, wherein: each AI persona from the list of AI personas comprises a unique accent, unique traits, and a unique background history; receive from a user a selection of one or more digital project files, wherein: at least one digital project file is managed by a third party; accessing the one or more digital project files within a content storage database, wherein the content storage database comprises: one or more storage databases; processing the one or more digital project files using the preferred AI persona, wherein: the preferred AI persona identifies information of interest within the one or more digital project files based upon the unique traits and the unique background history of the preferred AI persona; playing one or more music audio files for the user, wherein the one or more music audio files are selected based upon the one or more digital project files; and after a music audio file completes, generating, with the preferred AI persona, an audio conversation with the user, wherein the audio conversation is based upon the information of interest within the one or more digital project files.

Further, the methods may be practiced by a computer system including one or more processors and computer-storage media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line-based user interface, function key or hot key user interfaces, and the like.

Disclosed embodiments may comprise or utilize a special purpose or general-purpose computer including computer hardware, as discussed in greater detail below. Disclosed embodiments also include physical and other computer-storage media for carrying or storing computer-executable instructions and/or data structures. Such computer-storage media can be any available media that can be accessed by a general purpose or special purpose computer system. Computer-storage media that store computer-executable instructions are physical storage media.

Physical computer-storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry program code in the form of computer-executable instructions or data structures, and which can be accessed by a general purpose or special purpose computer. Combinations of the above are also included within the scope of computer-storage media.

Further, upon reaching various computer system components, program code means in the form of computer-executable instructions or data structures can be transferred automatically from transmission computer-readable media to physical computer-storage media (or vice versa). For example, computer-executable instructions or data structures received over a network or data link can be buffered in RAM within a network interface module (e.g., a “NIC”), and then eventually transferred to computer system RAM and/or to less volatile physical computer-storage media at a computer system. Thus, physical computer-storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for operating an interactive artificial intelligence digital radio station, comprising:
one or more processors; and
one or more computer-storage media having stored thereon executable instructions that when executed by the one or more processors configure the computer system to perform at least the following:
receive from a user a selection of a preferred artificial intelligence (“AI”) persona from a list of AI personas, wherein:
each AI persona from the list of AI personas comprises a unique accent, unique traits, and a unique background history;
receive from a user a selection of one or more digital project files, wherein:
at least one digital project file is managed by a third party;
access the one or more digital project files within a content storage database, wherein the content storage database comprises:
one or more storage databases;
process the one or more digital project files using the preferred AI persona, wherein:
the preferred AI persona identifies information of interest within the one or more digital project files based upon the unique traits and the unique background history of the preferred AI persona;
play one or more music audio files for the user, wherein the one or more music audio files are selected based upon the one or more digital project files; and
after a music audio file completes, generate, with the preferred AI persona, an audio conversation with the user, wherein the audio conversation is based upon the information of interest within the one or more digital project files.

2. The computer system of claim 1, wherein the executable instructions include instructions that are executable to configure the computer system to:
cause the preferred AI persona to identify updated material within the one or more digital project files.

3. The computer system of claim 2, wherein the executable instructions include instructions that are executable to configure the computer system to:
cause the preferred AI persona to identify updated material within the one or more digital project files, wherein the preferred AI persona is caused to identify updated material based upon a predetermined time cycle.

4. The computer system of claim 2, wherein the executable instructions include instructions that are executable to configure the computer system to:
receive a notification from the one or more digital project files that material has been updated; and
cause the preferred AI persona to identify updated material within the one or more digital project files.

5. The computer system of claim 2, wherein the executable instructions include instructions that are executable to configure the computer system to:
after the music audio file completes, generate, with the preferred AI persona, the audio conversation with the user, wherein the audio conversation is based upon the updated material within the one or more digital project files.

6. The computer system of claim 1, wherein the executable instructions include instructions that are executable to configure the computer system to:
receive from the user another selection of a different AI persona from the list of AI personas, wherein:
the different AI persona comprises a different unique accent, different unique traits, and a different unique background history.

7. The computer system of claim 6, wherein the executable instructions include instructions that are executable to configure the computer system to:
process the one or more digital project files using the different AI persona, wherein:
the different AI persona identifies different information of interest within the one or more digital project files based upon the different unique traits and the different unique background history of the different AI persona;
play one or more different music audio files for the user, wherein the one or more different music audio files are selected based upon the one or more digital project files; and
after a different music audio file completes, generate, with the different AI persona, a different audio conversation with the user, wherein the different audio conversation is based upon the different information of interest within the one or more digital project files.

8. The computer system of claim 1, wherein the one or more digital project files comprise image-based content.

9. The computer system of claim 8, wherein the executable instructions include instructions that are executable to configure the computer system to:
process the image-based content using the preferred AI persona;
play the one or more music audio files for the user, wherein the one or more music audio files are selected based upon the image-based content; and
after the music audio file completes, generate, with the preferred AI persona, the audio conversation with the user, wherein the audio conversation is based upon the image-based content.

10. A computer-implemented method for operating an interactive artificial intelligence digital radio station, comprising:
receiving from a user a selection of a preferred artificial intelligence (“AI”) persona from a list of AI personas, wherein:
each AI persona from the list of AI personas comprises a unique accent, unique traits, and a unique background history;
receive from a user a selection of one or more digital project files, wherein:
at least one digital project file is managed by a third party;
accessing the one or more digital project files within a content storage database, wherein the content storage database comprises:
one or more storage databases;
processing the one or more digital project files using the preferred AI persona, wherein:
the preferred AI persona identifies information of interest within the one or more digital project files based upon the unique traits and the unique background history of the preferred AI persona;
playing one or more music audio files for the user, wherein the one or more music audio files are selected based upon the one or more digital project files; and
after a music audio file completes, generating, with the preferred AI persona, an audio conversation with the user, wherein the audio conversation is based upon the information of interest within the one or more digital project files.

11. The computer-implemented method of claim 10, further comprising:
causing the preferred AI persona to identify updated material within the one or more digital project files.

12. The computer-implemented method of claim 11, further comprising:
causing the preferred AI persona to identify updated material within the one or more digital project files, wherein the preferred AI persona is caused to identify updated material based upon a predetermined time cycle.

13. The computer-implemented method of claim 11, further comprising:
receiving a notification from the one or more digital project files that material has been updated; and
causing the preferred AI persona to identify updated material within the one or more digital project files.

14. The computer-implemented method of claim 11, further comprising:
after the music audio file completes, generate, with the preferred AI persona, the audio conversation with the user, wherein the audio conversation is based upon the updated material within the one or more digital project files.

15. The computer-implemented method of claim 10, further comprising:
receiving from the user another selection of a different AI persona from the list of AI personas, wherein:
the different AI persona comprises a different unique accent, different unique traits, and a different unique background history.

16. The computer-implemented method of claim 15, further comprising:
processing the one or more digital project files using the different AI persona, wherein:
the different AI persona identifies different information of interest within the one or more digital project files based upon the different unique traits and the different unique background history of the different AI persona;
playing one or more different music audio files for the user, wherein the one or more different music audio files are selected based upon the one or more digital project files; and
after a different music audio file completes, generating, with the different AI persona, a different audio conversation with the user, wherein the different audio conversation is based upon the different information of interest within the one or more digital project files.

17. The computer-implemented method of claim 10, wherein the one or more digital project files comprise image-based content.

18. The computer-implemented method of claim 17, further comprising:
process the image-based content using the preferred AI persona; and
play the one or more music audio files for the user, wherein the one or more music audio files are selected based upon the image-based content.

19. The computer-implemented method of claim 18, further comprising:
after the music audio file completes, generating, with the preferred AI persona, the audio conversation with the user, wherein the audio conversation is based upon the image-based content.

20. A computer-storage media comprising one or more physical computer-storage media having stored thereon computer-executable instructions that, when executed at a processor, cause a computer system to perform a method for operating an interactive artificial intelligence digital radio station, the method comprising:
receiving from a user a selection of a preferred artificial intelligence (“AI”) persona from a list of AI personas, wherein:
each AI persona from the list of AI personas comprises a unique accent, unique traits, and a unique background history;
receive from a user a selection of one or more digital project files, wherein:
at least one digital project file is managed by a third party;
accessing the one or more digital project files within a content storage database, wherein the content storage database comprises:
one or more storage databases;
processing the one or more digital project files using the preferred AI persona, wherein:
the preferred AI persona identifies information of interest within the one or more digital project files based upon the unique traits and the unique background history of the preferred AI persona;
playing one or more music audio files for the user, wherein the one or more music audio files are selected based upon the one or more digital project files; and
after a music audio file completes, generating, with the preferred AI persona, an audio conversation with the user, wherein the audio conversation is based upon the information of interest within the one or more digital project files.
